(19) United States
(12) Patent Application Publication
(10) Pub. No.: US 2009/0186323 A1
(43) Pub. Date: Jul. 23, 2009

(54) Vertical English Character and Calligraphy

(76) Inventor: Yongsheng Zhao, Brea, CA (US)

Correspondence Address: Yongsheng Zhao, 1717 E Birch Street, Apt.D203, Brea, CA, 92821, US

(21) Appl. No.: 12/271,863

(22) Filed: Nov. 15, 2008

Related U.S. Application Data
(60) Provisional application No. 61/022,317, filed on Jan. 19, 2008.

(51) Int. Cl. G09B 1/00; G09B 11/00; G09B 19/00

(52) U.S. Cl. 434/159; 434/162; 434/156

(57) ABSTRACT

The present invention provides a method to create Vertical English Character (VEC) and calligraphy. The Characters including one-block structure, two-block structure, up elbow structure, down elbow structure and three-block structure are disclosed. The invention is suitable to build up fine art scripts, calligraphies and artworks.

### CROSS-REFERENCE TO RELATED APPLICATION(S)

This application claims the benefit of U.S. Provisional Patent Application No. 61/022,317, filed Jan. 19, 2008, the disclosure of which is incorporated by reference.

### BACKGROUND

Writing is an art. The term can be derived from the Greek word for “good” or “beautiful”. It implies a sure knowledge of the correct form of the skill to inscribe words with such cultivated ordering, knowing eye will recognize the composition as a work of art. The writings in the world have either aspired to or attained the status of calligraphy.

In East Asia, calligraphy by long and exacting tradition is considered a major art, equal to painting. It uses characters to communicate the spiritual world of the artist. Through the medium of form, way of handling the pen or brush, the calligraphy as a work of art conveys the moral integrity, emotions, esthetic feelings and culture of the artist to readers.

In Western culture, the spread of literacy tend to make handwriting theoretically “everybody's art,” especially since the Renaissance. Modern western calligraphy displays itself in the form of wedding and event invitations, maps, and other works involving writing. But some of today's calligraphy has little to do with the artistic discipline of each word, instead of simply good penmanship of letters that attracts attention and has a style of its own.

East Asian calligraphic achievements benefit from the characters. The character as “whole-word” writing is easier to arrange and make a harmony proportion than linear strings of letters. The art effect could be emphasized by the invisible square framework within which each character occupied.

In order to enhance the art attraction and get the “whole-word” effects as Characters for English, some inventors suggested and developed Yingzhi (by Mark Rosenfelder, http://www.zompist.com/yingzi/yingzi.htm) and New English Calligraphy (by XuBing, www.xubing.com) based on Chinese. However, these kinds of inventions cannot be widely adopted by the common people, because they are neither English nor Chinese. Actually, none can understand them if there is no special training.

### SUMMARY OF THE INVENTION

In this patent application, a readable English character version, Vertical English Character (VEC), and its calligraphy are applied. VEC absorbs the characteristics of pictographic methodology of Chinese and complies with the conventions of English. It is a new creature by combining western and eastern writing cultures. The art attractiveness could be comparable with fine art as paintings. The beauties could be appreciated regardless the meaning itself. The advantage of VEC writing is readable even if the visitors are not trained. The definitions of the single and multi-block structures, rules and strategies to build up VECs will be disclosed herein. Most of English words could be converted into VEC version with these techniques. This invention can also be used to create vertical characters for other languages written with alphabets such as French, German, Spanish, Italian, Portuguese and etc.

VEC adopts the English fonts with vertical Asian layout arranged from top to bottom, which could be obtained by rotating the horizontal words 90 degrees. The similar arrangement can be found in some posters and slogans in western writing system. The critical differences of VECs with the vertical English words are the writing style and methodology. VECs are generally a tall and neat version written within visible or invisible square framework, they look like symmetrical in shape even if they're not. The letters as the components of the characters are selected from English fonts, scripts, handwritings, or calligraphies, but they are quite flexible. The word is treated as a whole by extending the strokes, rotating and changing the size of letters to form them with such harmony of the proportions that the word can be recognized as an imaginary character. The effect is so graceful that the characters can be taken as a work of art with aesthetic qualities, it is so called calligraphy. VEC calligraphy could be written on the sheet with or without grid depending upon the preference of the creators. The text of VEC can be ranged horizontally from left to right in rows as well as vertically from top to bottom in columns. It also can be ranged in sector or other shapes.

Wide applications can be found to make the art works, crafts, logos and other decorative designs, such as T-shirts, sweatshirts, tattoos, or body arts. It is also suitable to engrave onto stones, rubbers or woods to fabricate tablets, chops (named seals, or signets) and other engraving products.

### BRIEF DESCRIPTION OF THE DRAWINGS

FIGS. 1 A to 1 E are illustrations of VEC structures. FIG. 1 A is a one-block structure, FIG. 1 B is a two-block structure, FIG. 1 C is an up elbow block structure, FIG. 1 D is a down elbow block structure and FIG. 1 E is a three-block structure. We call the structures of FIG. 1 B to 1 E “multi-block structures” as well.

FIG. 2 is a table of VEC characters created by the five types of structures as defined in the FIG. 1 A to 1 E.

FIG. 3 is a table of technical strategies for VECs creation.

FIG. 4 A is a example of VEC characters created with the one-block structure. The words are randomly selected from A to Z each. They are: and, better, can, dream, English, first, gain, high, idea, join, king, lady, more, new, one, plan, queen, rich, said, tiger, USA, very, work, xing, yes and zero. FIG. 4 B shows the examples of VEC characters created with multi-block structures. They are: unless, education, Monday, Newport, brushing, comfortable, enjoyment, calligraphy, drawing, happiness, writing, revolution, Yesterday, lawyers and unyielding.

FIG. 5 shows VEC text format with horizontal arrangement. The series number represents the sequence of VEC characters.

FIG. 6 shows VEC text format with vertical arrangement. The series number represents the sequence of VEC characters.

FIGS. 7A to 7 D are VEC calligraphic works created by pen. The content of FIGS. 7 A and 7 B is “well done is better than well said”, and the content of FIGS. 7 C and 7 D is “nothing happens unless first a dream”.

FIGS. 8 A to 8 D are VEC works created by pointed brush. The content of FIGS. 8 A and 8 C is “dream”, and the content of FIGS. 8 B and 8 D is “magic”.

FIGS. 9A to 9 D are VEC works created by a broad brush. The content of FIGS. 9 A and 9 C is “sale”, and the content of FIGS. 9 B and 9 D is “yard”.

FIGS. 10A and 10 B are VEC signet works engraved on stone by metal chisels. The content is “fine art”.

### DETAIL DESCRIPTION

Methods, structures, technical rules and strategies to create Vertical English Character (VEC) and calligraphy are disclosed herein.

VECs are generally a tall and neat English character created within visible or invisible square framework. They look like symmetrical in shape even if they're not. The letters as components of the characters are selected from traditional English fonts, scripts, handwritings, or calligraphies. The word is treated as a whole with such harmony that it can be recognized as an imaginary character. VECs can be built up with five types of structures, which are defined as type A to E. We call type A “single block structure” and type B to E “multi-block structures” as well in a convenience.

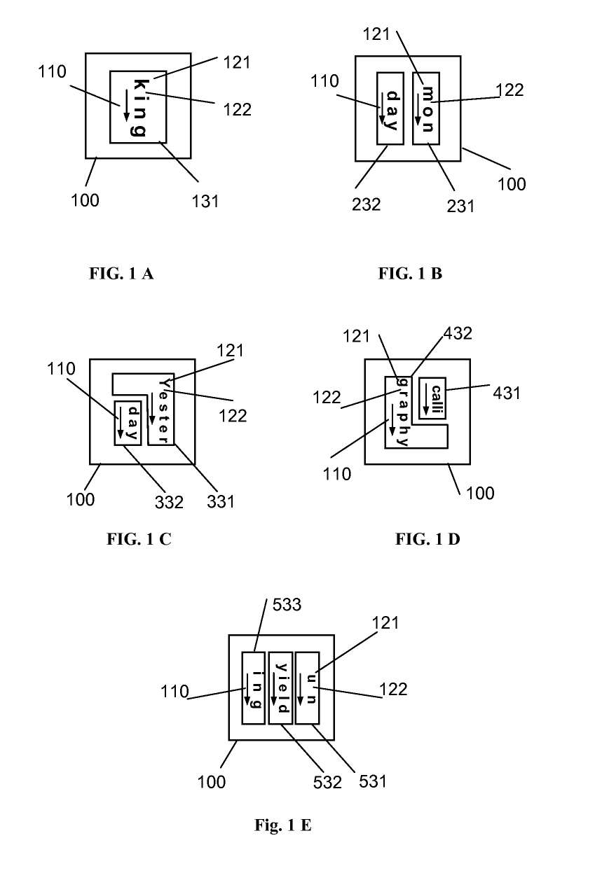

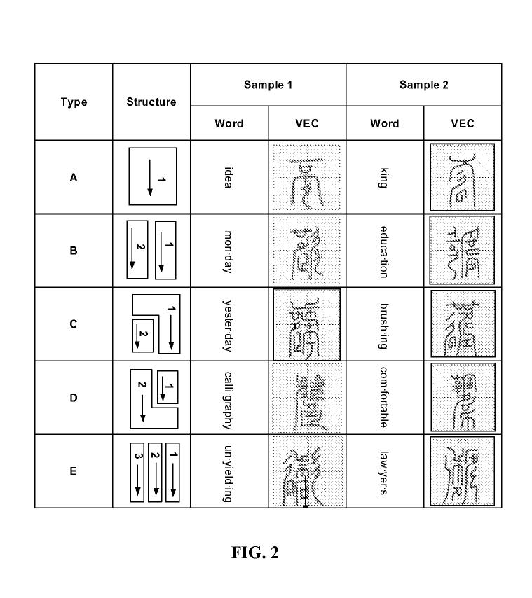

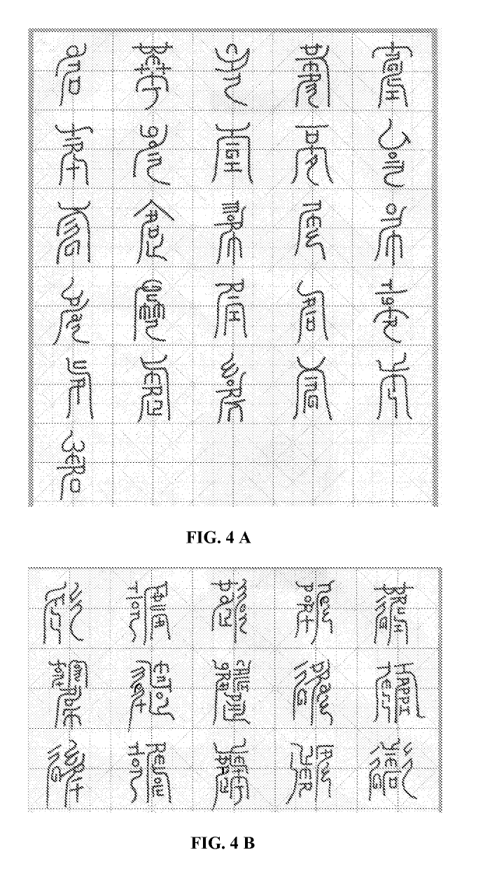

Type A is a one-block structure as illustrated in FIG. 1 A. The character is created in a visible or invisible square area 100 by rotating the word in 90 degrees clockwise to appear vertical 110 instead of the original horizontal arrangement. The letters 121 as components of the character are assembled in a block 131 inside of square area 100 by the technique rules as defined in this application. The block 131 is the outline of a character, its area is equal or smaller than square area 100, and the ratio of high to wide of the block may uneven depending upon the actual size and shape created. The block 131 is invisible in actual VECs. The samples of this type of characters are as shown in first row of FIG. 2 and more can be found in FIG. 4 A.

Type B is a two-block structure as illustrated in FIG. 1 B. VEC creators can divide some words, such as polysyllabic and compound words, into two sections by roots, prefixes, suffixes, or syllables (for instance, the word “monday” can be broken into mon+day), and then assembled into two blocks 231/232 vertically 110 from right 231 to left 232, which just like a long English word in typing allows to be divided and put into the next line. Each of the blocks 231/232 can be treated and assembled as same as one-block 131 structure of type A. A united body of the character will be generated by combining the two blocks 231/232 together in the square area 100. Some strokes of the letters 121 are allowed to extend from one block into another in order to set up a relationship and get a whole imaginary character. The ratios of high to wide for the two blocks 231/232 may uneven depending on the aesthetic consideration of VEC creators. As same as type A, the outlines of both blocks 231/232 will not appear in the final characters. The samples of type B are shown in the row B of FIG. 2 and more can be found in FIG. 4 B.

Type C is a structure with an up elbow block as illustrated in FIG. 1 C. This is another design of the two-block structure. The word is divided into two sections and assembled into two blocks 331/332 as same as type B. The difference is that the right block 331 is extended into the left side at the top of block 332 as an elbow. The extension part could be a letter, a syllable, a prefix or an interesting portion needs to be emphasized. Western calligraphy has a long tradition of enlarging the initial majuscule or first word of text to enhance the visual appeal of a written document. The similar definition has been adopted in this structure. There are two samples of this type of characters have shown in the row C of FIG. 2.

Type D is a structure with a down elbow block as illustrated in FIG. 1 D. This is the third design of the two-block structure similar as type B, but the elbow block 432 is extended from left to right at the bottom of block 431. The extended part could either be a letter, a syllable, a root, a suffix or an interesting portion needs to be emphasized. The related samples are shown in row D of FIG. 2.

Type E is a three-block structure as illustrated in FIG. 1 E. A polysyllabic or compound word can be divided into three sections depending upon the roots, prefixes, suffixes, syllables or aesthetic considerations (for instance, the word of “unyielding” could be broken into un+yield+ing), and then vertically 110 assembled into three blocks 531/532/533 from right 531 to left 533 respectively. Each of the blocks 531/532/533 will be treated and assembled as same as one-block 131 structure of type A. A united body of the character will be generated by combining the three blocks 531/532/533 together in the square area 100. Some strokes of the letters 121 are allowed to extend from one block into other blocks in order to set up a relationship and get a whole imaginary character. The ratios of high to wide for these three blocks 531/532/533 may uneven depending on the aesthetic consideration of the creators. As same as type A, outlines of the three blocks 531/532/533 will not appear in the final characters. The related samples are shown in the row E of FIG. 2.

The technical rules to create VECs by using one of the structures above are defined as follow:

1. The prototype style of letters 121 will be selected from one of the English fonts, Scripts, handwritings or calligraphies. Uppercase and lowercase letters are identified as different components (or radicals), but there are no distinctive in the position, creators can use either of them to build up the characters freely.

2. Creators can enlarge, reduce, twist, rotate or extent the letters 121 and strokes to make a harmonic pattern distribution with same or different weights. Because the letters 121 are individually applied, the creators could easily assemble them to match his/her needs. It is particularly useful to make the artistic level of VECs.

3. The individually applied letters 121 enable creators to adjust the letter spacing 122 either by opening out or having them very close. Creators can join the letters 121, combine or overlap the strokes if necessary.

4. Normal typography and lettering place all the letters on a common baseline they are aligned. Vertical English Character permits creators to offset the letters 121 by shifting left or right from the baseline. But the letter's sequence should keep in series except in the case of same letters, so that the words could be recognized without any difficulty.

5. Usually, each letter 121 occupies its own space and the spacing 122 between letters are constant. Vertical English Character allows creators to interlock and extend the strokes of letters into one another's space. It is critically important to set up the relationship of the letters for creating a “whole-word” character.

In some embodiments, the following technical strategies are useful to create the beautiful VECs:

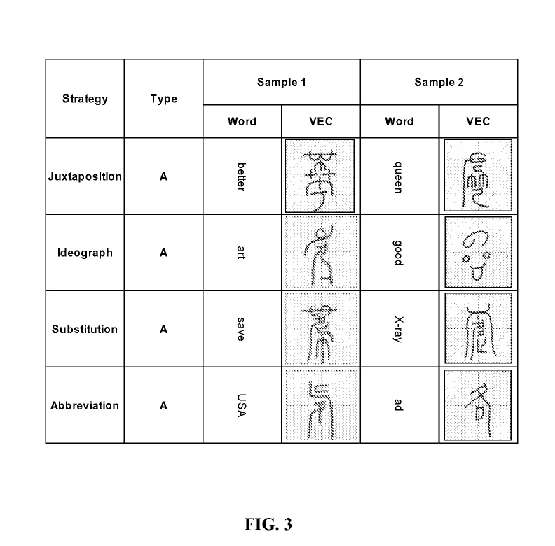

1. VEC permits same letters 121 to be juxtaposed in some cases. This strategy is rational, since there is no problem to recognize the word within this definition. The related examples are shown in the first row of FIG. 3, wherein the letters “tt” in the word of “better”, and letters “ee” in the word of “queen” are treated as juxtaposition in the characters.

2. In some embodiments, some ideographic characters can be invented. For example, a smiling face was built up by the word of “good”, and gymnast was created from the word of “art”. In general, an ideographic character could represent an abstract concept with the shape of the ideograph associated. The samples of ideographic VEC characters are shown in the second row of FIG. 3.

3. In some embodiments, creators do not need to use the alphabetic letters only. Interesting ideas can be expressed by inserting other elements into the characters, such as numerals, punctuation marks, math, accounting, and science symbols. The related examples can be found in the third row of FIG. 3, wherein the letter of “s” is replaced by “$” in the word of “save” and a symbol of “-” is inserted between X and ray in the character.

4. In some embodiments, creators can use the standard abbreviation or shorthand words to build up VECs. This strategy is helpful to build up long English words. As examples of VECs created from abbreviated words are shown in the last row of FIG. 3. They are USA (=United States of America) and ad (=advertisement).

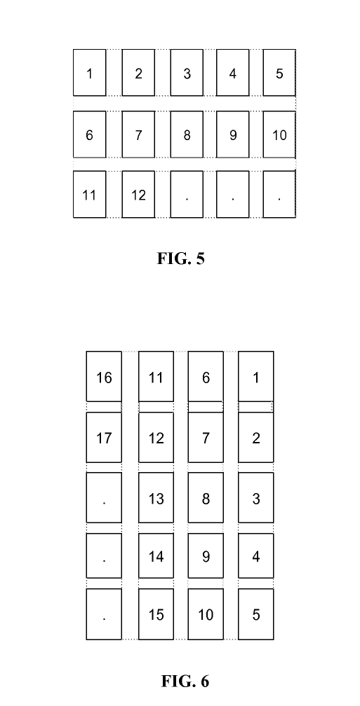

The VEC text can be arranged horizontally from left to right in one row with successive rows going from top to bottom as same as regular English printing. FIG. 5 illustrates the text of VEC with three rows in this format. The series number represents the sequence of VEC characters. The related example can be found in FIG. 4 A, where the characters are arranged from A to Z by the first letter of the words. They are: and, better, can, dream, English, first, gain, high, idea, join, king, lady, more, new, one, plan, queen, rich, said, tiger, USA, very, work, xing, yes and zero.

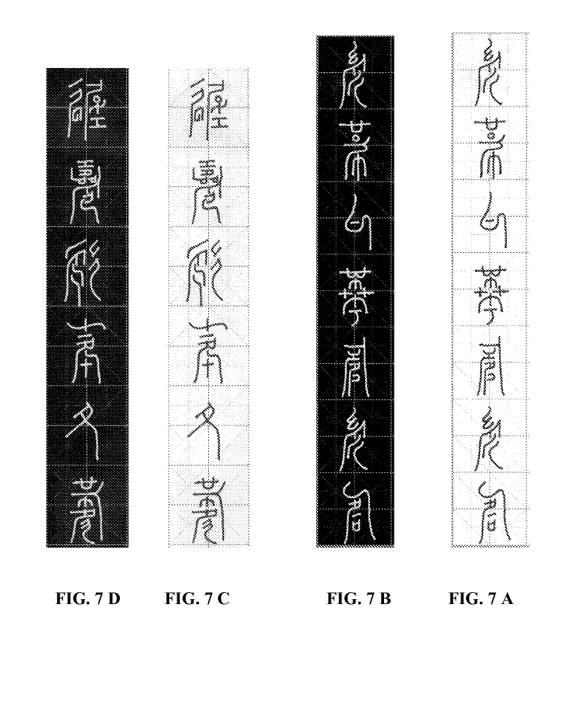

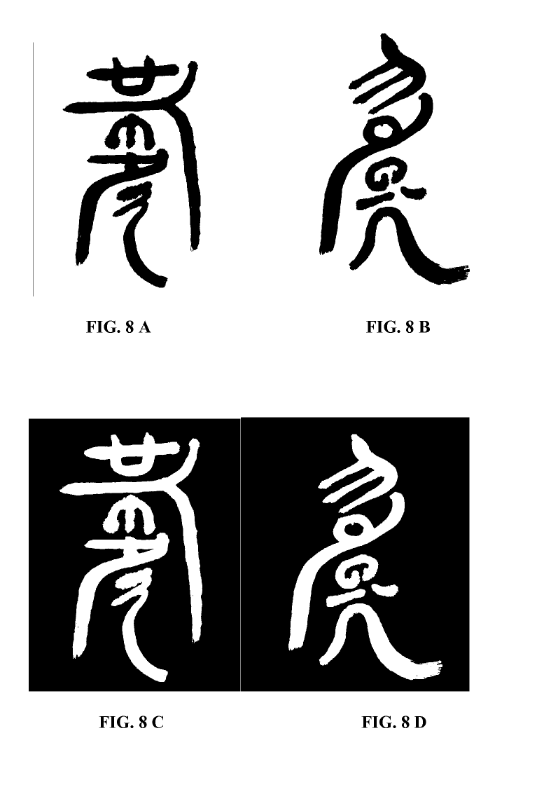

VEC text can also be arranged vertically from top-to-bottom in one column with successive columns displayed vertically from right-to-left. This kind of format has been widely adopted in East Asia. FIG. 6 illustrates the text of VEC with four columns in the vertical format. The series number represents the sequence of VEC characters. The example of this format has disclosed in FIG. 7.

Both horizontal and vertical formats can be used if the VEC text is just in one line horizontally.

Common tools to create VECs are pens and brushes. Pens could be made from reeds, feathers, fibers or metals and their ends can be shaped to broad-edges or fine point tips such as fountain pens, dip pens, and ball pens. Brushes could be either broad-edges or fine points. Their tips are more flexible than pens. Water-, oil-based inks or paints can be used with brushes to create VECs on any surface such as paper, wood, cloth, glass, stone or metal. Practice sheets with grid are helpful for beginners to practice. The art effect could be emphasized using suitable pens, brushes and papers.

Other tools such as felt- or fiber-tipped markers, chalks, pencils, sprayers, Mallets, metal chisels and diamond pens can also be used to create VEC artworks on paper, wood, stone, metal, cloth, glass and wall.

In the embodiment of FIG. 7, the VECs were written with vertical arrangement by pen on the practice work sheet. The content of FIG. 7 A is “well done is better than well said”. The content of FIG. 7 C is “nothing happens unless first a dream”. The corresponding reversed versions are shown in FIG. 7 B and FIG. 7 D. The art effects are quite difference with original writings.

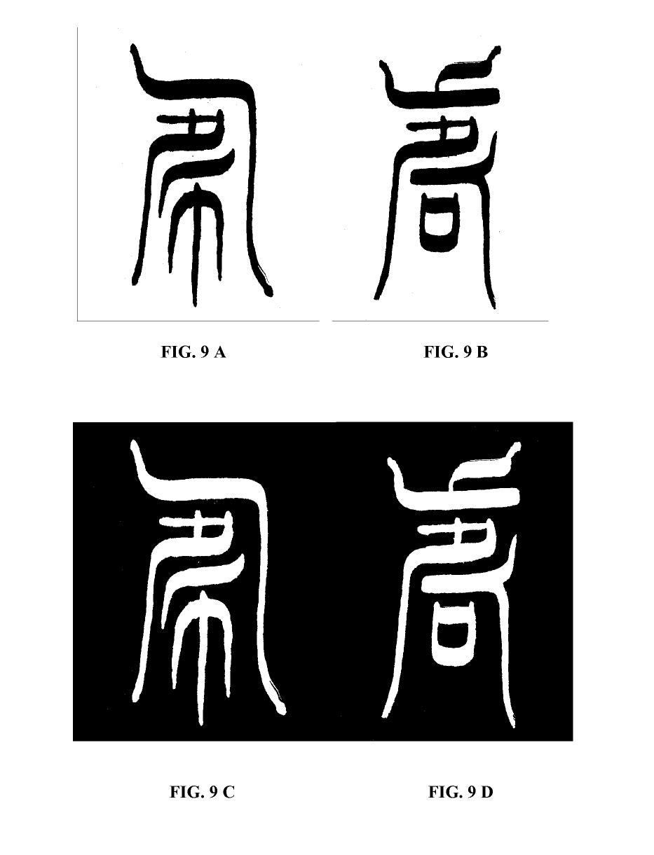

In the embodiments of VEC calligraphic artworks, which were written by a pointed brush on the paper, are shown in FIGS. 8 A and 8 B. They are “dream” and “magic” respectively. The corresponding reversed versions are also shown in FIGS. 8 C and 8 D.

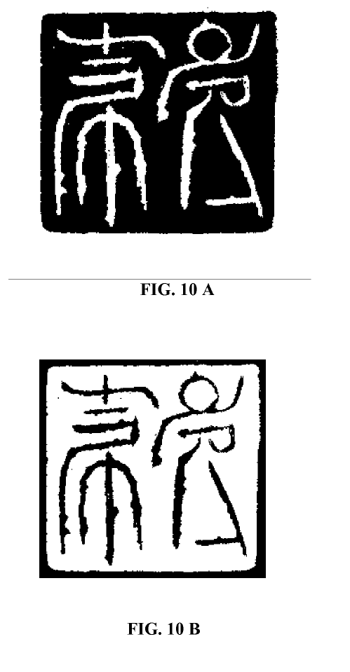

In the embodiment of VEC calligraphic artworks, which were written by a broad brush on the paper, are shown in FIGS. 9 A and 9 B. They are “sale” and “yard” respectively. The corresponding reversed versions are also shown in FIGS. 9 C and 9 D.

In the embodiments of VEC calligraphic characters, which were engraved on stone by metal chisels, are shown in FIG. 10 A. The content is “fine art”. It is a style of signet with a horizontal arrangement. The corresponding reversed version is shown in FIG. 10 B.

Different styles of VECs can be created by using different tools or/and by different creators. As same as any calligraphy, the beautiful VEC artworks can be achieved by long term practice and training.

What is claimed is:

1. The method for building up a graphical Vertical English Character (VEC) and calligraphy by rotating the English word 90 degrees clockwise, wherein the letters as the components of the character are assembled in a visible or invisible square area with one of five structures: one-block structure, two-block structure, up elbow structure, down elbow structure and three-block structure.

2. Vertical English Character and calligraphy of claim 1, wherein the letters can be selected from the English fonts, scripts, handwritings or calligraphies, there are no distinctive for uppercase and lowercase letters.

3. Vertical English Character and calligraphy of claim 2, wherein the components of the letters are allowed to rotate from 0 to +/−89 degrees to set up the harmonic graphical patterns.

4. Vertical English Character and calligraphy of claim 2, wherein the components of the letters are allowed to be enlarged or reduced from 0% to (+/−) 1000% in order to get a graphical character.

5. Vertical English Character and calligraphy of claim 2, wherein the components of the letters are allowed to twist, extend or reduce the strokes to make a relationship between letters, but the letters must be readable without any difficulty.

6. Vertical English Character and calligraphy of claim 5, wherein the strokes of the letters are allowed to interlock into other space of the letters to generate a “whole-word” character.

7. Vertical English Character and calligraphy of claim 5, wherein the size of the strokes of the letters can be thin or thick with same or different weight in one character or between different characters.

8. Vertical English Character and calligraphy of claim 1, wherein the letters are allowed to offset left or right 0 to 99% of the letter size from central baseline.

9. Vertical English Character and calligraphy of claim 1, wherein the spacing of the letters can be set from 0 to 50 times within normal space.

10. Vertical English Character and calligraphy of claim 1, wherein the components of the character can be assembled from full to one fifth in height, or/and from full to one fifth in width at inside of the square area by using one of five structures.

11. Vertical English Character and calligraphy of claim 1, wherein the letters of character are assembled vertically from top to bottom in one-block structure and from left to right block by block in the multi-block structures.

12. Vertical English Character and calligraphy of claim 1, wherein the words are divided and assembled in multi-block structures by the roots, prefixes, suffixes, syllables or any interesting portions need to be emphasized.

13. Vertical English Character and calligraphy of claim 1, wherein the up elbow structure, the right side block is extended into left side at top as an elbow, the extension part can be a letter, a syllable, a prefix or an interesting portion where needs to be emphasized.

14. Vertical English Character and calligraphy of claim 1, wherein the low elbow structure, the left side block is extended into right side at bottom as an elbow, the extension part can be a letter, a syllable, a suffix or an interesting portion where needs to be emphasized.

15. Vertical English Character and calligraphy of claim 1, wherein the blocks as the part of the structures are allowed to be uneven in both horizontal and vertical directions.

16. Vertical English Character and calligraphy of claim 1, wherein the characters can be arranged horizontally from left-to-right in one row with successive rows going from top-to-bottom, or arranged vertically from top-to-bottom in one column with successive columns displayed from right-to-left to generate a text, artworks, or calligraphy, sector or other shapes of arrangements are also feasible options for VEC creators.

17. Vertical English Character and calligraphy of claim 1, wherein the characters can be created using a fine point or broad-edge pen or/and brush by water-, oil-based inks or paints on the paper, wood, cloth, glass, stone, metal or wall.

18. Vertical English Character and calligraphy of claim 1, wherein the characters can be created by chisel, mallet or spray gun, or etching techniques on the paper, wood, cloth, glass, stone metal or wall.
